(19) United States
(12) Patent Application Publication
(10) Pub. No.: US 2025/0314478 A1
(43) Pub. Date: Oct. 9, 2025

(54) DEVICE FOR STEREOVISION OF A HOT TRANSLUCENT CONTAINER

(71) Applicant: KONATIC, VOURLES (FR)

(72) Inventor: Guillaume BATHELET, VOURLES (FR)

(21) Appl. No.: 18/717,315

(22) PCT Filed: Dec. 8, 2022
(86) PCT No.: PCT/EP2022/085006

§ 371 Date: Oct. 30, 2024

(30) Foreign Application Priority Data
Dec. 8, 2021 (FR) FR2113152

(51) Int. Cl. G01B 11/10

(52) U.S. Cl. CPC G01B 11/105

(57) ABSTRACT

The invention relates to a device for stereovision of a hot translucent container.

The stereovision device (2) comprises a colour distance sensor (4), an infrared optical sensor (6), a control unit (8) comprising a storage module (24) including a database and a control method implementing the following steps:
i. the control unit (8) measuring, via the colour distance sensor (4), a distance (E′) between the sensor (4) and a container (34);
ii. the computing module (26) measuring, via the infrared optical sensor (6), the position (P′) and a dimensional measurement (D′) of the container (34);
iii. identifying, from the database, a value (R) correlated with the measurements (E′, P′, D′) carried out in steps i and ii;
iv. identifying a defect in the container (34).

### PRIOR ART

The present invention relates to the technical field of manufacturing glass containers by hot forming. More particularly, the invention relates to a stereovision device adapted to implement a method for controlling glass containers dimensions, at exit from a hot-forming mould.

### BACKGROUND OF THE INVENTION

As known, glass containers are manufactured using a hot-forming technique. This technique consists in heating a glass drop to more than 1000° C. in a mould, then injecting a gas into the glass drop in order to press the faces thereof against the mould walls. At the mould exit, a glass container of the desired shape is obtained.

It may turn out that over time, for a variety of reasons known to the person skilled in the art, the glass containers from a same mould have slightly different shapes and dimensions. In order to guarantee uniformity of production, quality controls are carried out frequently in order to identify, then remove, the non-compliant containers.

It is known to use stereovision devices to measure, in real time, the shape as well as the dimensions of each glass container. For that purpose, it is necessary to have plenty of space around the conveyor that transports the glass containers, so as to be able to obtain a complete view of each glass container. That is why the stereovision devices are positioned downstream of the production line.

A mould malfunction will therefore be detected after a certain period of time, corresponding to the time taken for the non-compliant container to move from the mould to the stereovision device. During this time period, the mould continues to produce defective containers, which will also have to be discarded.

An alternative consists in picking-up containers at the mould exit and controlling the shape thereof using a template. Nevertheless, this solution has the disadvantage of irreversibly altering the containers' surface. The picked-up containers are then discarded.

To date, there is no three-dimensional detection system enabling to identify rapidly a malfunction of a mould, for hot forming glass containers, without damaging the glass containers exiting from the mould.

The invention aims to remedy this technical problem, by proposing a stereovision device or a device for remotely controlling the shape of a hot translucent container, enabling to measure, in real time and at least in part, the shape of each glass container exiting from a hot-forming mould, as close as possible to the mould, and without damaging the containers.

### SUMMARY OF THE INVENTION

For that purpose, the invention proposes a method for calibrating a stereovision device or a method for calibrating a device for remotely controlling the shape of a hot translucent container, comprising a chromatic distance sensor, an infrared optical sensor, the optical axis of the chromatic distance sensor and the optical axis of the infrared optical sensor intersecting each other or being secant, a control unit consisted of a storage module and a computation module. The control unit is connected to the chromatic distance sensor and to the infrared optical sensor.

By “connected”, it is meant the possibility for two elements of the stereovision device or the device for remotely controlling the shape of a hot translucent container to exchange information.

The invention is remarkable in that the calibration method implements the following steps:
a) positioning an object in the field of view of the sensors, the object being aligned or substantially aligned with the optical axis of the chromatic distance sensor and at least one dimension of the object is known;
b) measuring a distance between the object and the chromatic distance sensor;
c) measuring a position of the object and at least one dimension of the object, through the infrared optical sensor;
d) recording into a database contained in the storage module the measurements carried out at steps b) and c), in such a way that a known dimension of the object is correlated to the distance measurement, as well as to the measurement of at least one dimension of the object and the measurement of the position of the object, said measurements being carried out in the preceding steps.

The calibration method according to the invention advantageously allows to establish a correlation matrix or database, specific to a stereovision device or device for remotely controlling the shape of a hot translucent container according to the invention, between a known dimension of the object and the position thereof relative to the chromatic distance sensor and the dimension and position measurements of said objects by the infrared optical sensor. This correlation matrix advantageously makes it possible to establish a “signature” specific to each object, when the object moves in the field of view of the sensors.

By “chromatic distance sensor”, it is meant any type of optical device, adapted to measure a distance by a confocal imaging method.

According to another embodiment of the invention, at least one dimension of the object is known, in a plane defined by the optical axes of the sensors.

According to another embodiment of the invention, in step c), a dimension of the object is measured, in a plane defined by the optical axes of the sensors.

According to another embodiment of the invention, the object is cylindrical in shape, the longitudinal axis of the object being perpendicular or substantially perpendicular to the plane defined by the optical axes of the sensors, the outer diameter of the object being known.

According to another embodiment of the invention, steps a) to d) of the calibration method described hereinabove are reiterated after having moved the object along the optical axis of the chromatic distance sensor. Preferably, the object is moved several times along the optical axis of the chromatic distance sensor during the calibration method.

According to another embodiment of the invention, the optical axes of the sensors form an acute angle, whose value is between 0° and 85° or between 1° and 85°, preferably between 0° and 45° or between 1° and 45°.

According to an alternative embodiment, the optical axes of the sensors can be parallel to each other.

The invention also relates to a device for stereovision of a container or a device for remotely controlling the shape of a hot translucent container, comprising an infrared optical sensor, a chromatic distance sensor, the optical axes of the sensors intersecting each other or being secant, a control unit comprising a computation module and a storage module, the computation module being connected to the storage module, the control unit being connected to the sensors.

The stereovision device or device for remotely controlling the shape of a hot translucent container is remarkable in that the storage module comprises:
a database or a correlation matrix made based on a calibration method described hereinabove; and
a control method, implementing the following steps:
   i. measurement, by the control unit, via the chromatic distance sensor, of a distance between the chromatic distance sensor and a container present in the optical fields of the sensors;
   ii. measurement, by the computation module, via the infrared optical sensor, of the position and a dimension measurement of the container;
   iii. identification, from the database or the correlation matrix, of a value correlated with the measurements carried out in steps i and ii;
   iv. identification of a defect of the container, when the value exceeds a predetermined tolerance range.

Preferably, the container observed is made of glass, for example a bottle or a vial.

Preferably, steps i and ii are carried out simultaneously.

According to another embodiment of the invention, when a container moves in the field of view of the sensors, before step iii, steps i and ii are implemented several times.

According to another embodiment of the invention, between the last step ii and step iii, an intermediate step is implemented, consisting in identifying the shortest distance measured by the chromatic distance sensor, this shortest distance being taken into account during step iii to identify the value correlated to the measurements carried out at steps i and ii.

According to another embodiment of the invention, the control unit comprises an alert module connected to the computation module, and the alert module is activated by the computation module when the computation module identifies a defect of an observed container during the implementation of the control method.

According to another embodiment of the invention, the alert module is connected to a control module of a production unit.

According to an alternative embodiment, several stereovision devices as described hereinabove can be stacked onto each other so as to be able to carry out several measurements of a container along a direction normal or substantially normal to the plane defined by the optical axes of the sensors. This embodiment advantageously enables a three-dimensional modelling of a container moving in the field of view of the sensors.

The invention also relates to a glass container production line, comprising a mould for thermoforming glass containers, a conveyor adapted to move the containers exiting from the mould to a cooling arch.

The production line is remarkable in that a stereovision device or device for remotely controlling the shape of a hot translucent container as described hereinabove is present along the conveyor, between the mould and the cooling arch, the optical sensors being directed so as to detect the passage of each container moving on the conveyor.

According to another embodiment of the invention, the computation module measures, through the infrared optical sensor, a dimension measurement of the observed container, along a direction transverse to the optical axis of the infrared sensor and parallel or substantially parallel to the moving direction of the container on the conveyor.

According to another embodiment of the invention, the mould is connected to the stereovision device so as to stop operation of the mould, when the stereovision device detects a defect on a container moving on the conveyor.

According to another embodiment of the invention, at the entrance to the cooling arch, the temperature of the containers is equal to or higher than 400° C., preferably equal to or higher than 500° C.

According to an alternative embodiment, the stereovision device or device for remotely controlling the shape of a hot translucent container is adapted to implement a method for measuring a portion of the external perimeter of a container moving in the field of view of the sensors. For different positions of the container in the field of view of the sensors, the measuring method implements steps i to iii of the above-described control method. During each step iii, a value of distance between the chromatic distance sensor and the container is obtained from the measurements carried out in steps i and ii. These distance values are thereafter used to model the contour shape of the container facing the chromatic sensor or to model the full contour of the container.

According to an alternative embodiment, the measurement method described hereinabove is implemented at different heights of the container, so as to be able to model a three-dimensional shape which is representative of the container shape.

The measuring methods are preferably present in the storage module and implemented by the computation module of the stereovision device according to the invention.

Obviously, the different features, alternatives and embodiments mentioned hereinabove can be associated with each other according to various combinations, insofar as they are not incompatible or exclusive with respect to each other.

### BRIEF DESCRIPTION OF DRAWINGS

The invention will be better understood, thank to the following description, which relate to

preferred embodiments, given by way of non-limiting examples, and explained with reference to the attached schematic drawings, in which:

FIG. 1 illustrates a stereovision device or a device for remotely controlling the shape of a hot translucent container according to the invention;

FIG. 2 illustrates a first step of a method for calibrating a stereovision device shown in FIG. 1;

FIG. 3 illustrates another step of a method for calibrating a stereovision device shown in FIG. 1;

FIG. 4 illustrates another step of a method for calibrating a stereovision device shown in FIG. 1;

FIG. 5 illustrates a glass container production line comprising a stereovision device according to the invention, during a first step of a control method;

FIG. 6 illustrates a glass container production line comprising a stereovision device according to the invention, during a second step of a control method;

FIG. 7 illustrates a glass container production line comprising a stereovision device according to the invention, during a third step of a control method;

FIG. 8 illustrates a curve representing the variation of the distance measured between the container and the chromatic distance sensor, during the control method steps shown in FIGS. 5 to 7;

FIG. 9 illustrates a modelling of the full contour of a container based on measurements carried out during the control method.

### DETAILED DESCRIPTION OF THE INVENTION

As a reminder, the invention proposes a stereovision device or device for remotely controlling the shape of a hot translucent container, enabling to measure, in real time, the shape of glass containers exiting from a hot-forming mould, as close as possible to the mould, and without damaging the containers.

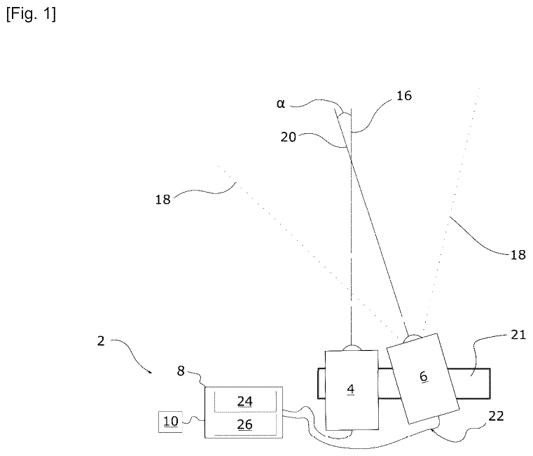

FIG. 1 illustrates a non-limiting embodiment of a stereovision device 2 or device for remotely controlling the shape of a hot translucent container according to the invention. The stereovision device is consisted of a distance sensor 4 of the chromatic type, an optical sensor 6 of the infrared type, a control unit 8 and an alert module 10.

As known, the chromatic distance sensor 4 is adapted to accurately measure the shortest distance to an object 12, located in the field of view of the sensor 4. For that purpose, the sensor 4 comprises a polychromatic light source. The light emitted by the light source is focused at different wavelengths, at variable distances, along an optical axis 16, represented in FIG. 1 by a dotted line. The optical axis 16 is directed towards the object 12 in such a way that the light source of the sensor 4 lights the surface of the object 12. The sensor 4 also integrates a light detector whose optical axis of detection is coincident with the optical axis 16, in such a way as to measure the quantity of light reflected by the object 12. By determining the wavelength of the focused light, which has been reflected by the object, very accurate distance measurements are measured between the sensor 4 and the object 12.

In other words, the sensor 4 records a digital image of the surface of the object 12, at a precise wavelength, corresponding to a perfect focus of the surface of the object 12 at said wavelength.

In the present example, the sensor 4 is a chromatic confocal sensor marketed under the reference CL-P070 by KEYENCE. This sensor is characterized by a measurement range of 70 mm+/−10 mm, with a linearity of 2.2 μm.

The stereovision device 2 includes a second sensor 6, an infrared optical sensor, adapted to detect a radiation included in a wavelength range extending from 700 nm to 2500 nm, preferably from 900 nm to 1700 nm. The field of view limits of the sensor 6 are illustrated in FIG. 1 by the dotted lines 18.

The field of view of the sensor 6 is characterized by a field angle between 4° and 85°,preferably between 15° and 35°. The dotted line 20 in FIG. 1 represents the optical axis of the sensor 6.

According to the present example, the sensor 6 is a camera marketed under the reference Ingaas C-RED 3 by First Light Imaging, with a resolution of 640 mm×512 mm for a spectral sensitivity of between 0.9 μm and 1.7 μm.

The stereovision device 2 according to the invention is thus consisted of a first sensor 4, recording a digital image of the surface of the object 12, at a specific wavelength, according to a first angle of observation (dotted line 16), and a second sensor 6, recording a digital image of the surface of the object 12, at several wavelengths and according to a second angle of observation (dotted line 20). The stereovision device 2 therefore makes it possible to take digital images of the object 12, according to different angles of view, to determine the position and the shape of the object 12, as will be explained hereinafter.

As illustrated by FIG. 1, the sensor 6 is positioned near the sensor 4 and directed in such a way that the field of view of the sensor 6 covers at least partially the field of view of the sensor 4.

The optical axes 16 and 20 are secant and form an angle a whose value is included in a range of values from 1° to 75°, preferably from 5° to 35°.

The sensor 6 and the sensor 4 are both mounted on a same support plate 21. The sensors are attached to the support plate via known means, such as screws or the like, so as to fix over time the position of the sensors on the plate and, more particularly, the angle α formed by the optical axes of said sensors.

The sensors are both connected to the control unit 8 by wired means 22. By “connected”, it is meant the possibility for two entities to exchange information. According to an alternative not shown, the sensors can also communicate with the control unit via wireless transmission means, of the WiFi or Bluetooth type.

The control unit 8 is consisted of a storage module 24 that is connected to a computation module 26. The computation module 26 includes a communication interface not shown, enabling the computation module to communicate with the sensors.

The computation module is also adapted to communicate with the alert module 10, in such a way as to inform a user or to signal to another device, a non-conformity of a container observed by the stereovision device 2.

Previously to the use of the stereovision device or device for remotely controlling the shape of a hot translucent container, it is recommended to carry out the calibration method described hereinabove.

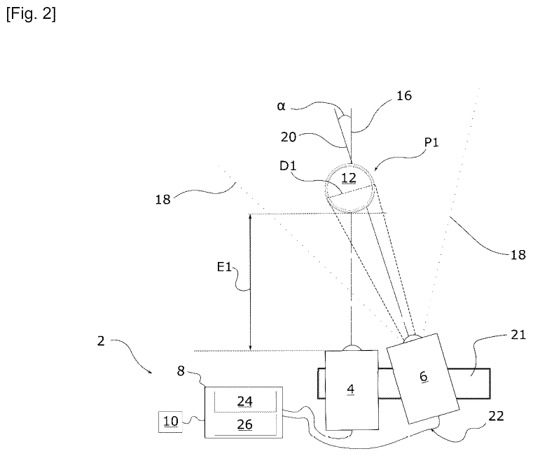

According to a first step illustrated in FIG. 2, an object 12 of known shape and dimensions is placed in the field of view of the sensors. In the present example, the object 12 is a cylindrical body whose longitudinal axis is positioned perpendicularly to the plane defined by the optical axes 16 and 20. The real diameter R of the object 12, defined in a plane radial to it longitudinal axis, is known. The object 12 is substantially aligned with the optical axis 16 of the distance sensor 4 and positioned at a first distance E1 measurable by the sensor 4.

According to a second step, the computation module 26 measures, using the sensor 6, the position P1 of the object 12, as well as its apparent diameter D1 within a plane defined by the optical axes 16 and 20.

In a third step, the measurements E1, D1 and P1, as well as the real diameter R of the object, are transmitted to the storage module 24 in such a way as to be recorded as a database, establishing a correlation link between the above-mentioned measurements. More precisely, the measurements are recorded in the database in such a way that the value R can be determined as a function of the measurements E1, P1 and D1.

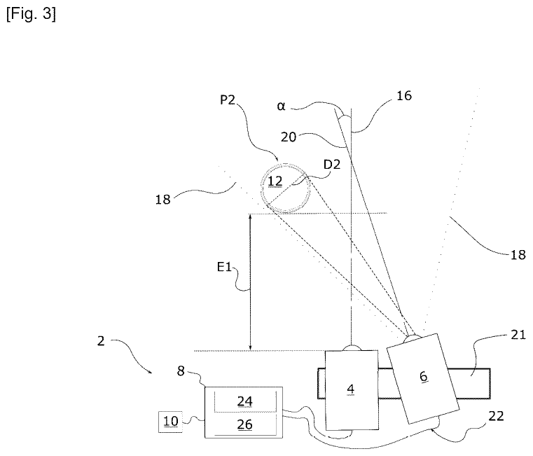

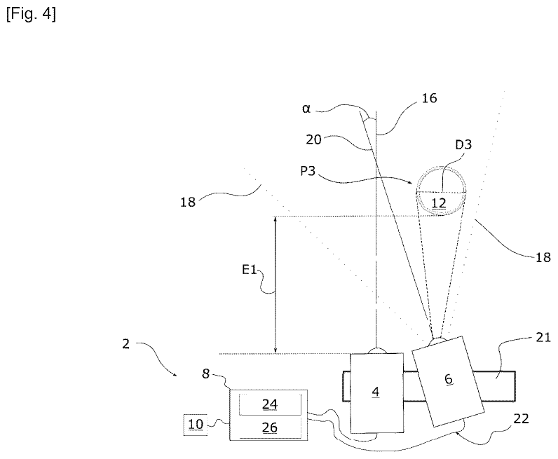

As illustrated in FIGS. 3 and 4, the object 12 is thereafter moved along a direction contained in a plane defined by the optical axes 16 and 20, and perpendicular to the optical axis 16. For each new position, the calibration steps described hereinabove are reproduced in such a way as to be able to determine the real diameter value R of the object, when the latter moves perpendicularly to the optical axis 16 of the distance sensor, based on the measurements E, P and D recorded in the database.

More precisely, the database is built as follows. At the end of the above-described steps, the values R, E, P and D are recorded on a same row of a matrix. A distinct column of the matrix is associated with each value R, E, P and D. The database then enables to associate with the value R, a single and same triplet of values (E, P, D).

It is advisable to reproduce the calibration method described hereinabove for different distance values E, between the object 12 and the sensor 4, in such a way as to enrich the database recorded by the storage module 24. Obviously, for each new triplet of values (E, P, D), a new row is created in the above-mentioned matrix, associating a unique value R with said triplet of values.

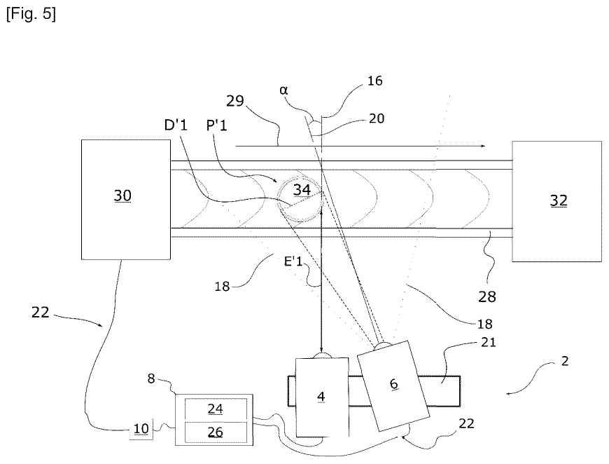

FIG. 5 illustrates an example of use of a stereovision device 2 as described hereinabove, to detect in real time a non-conformity of a glass container moving on a conveyor 28.

The stereovision device 2 is positioned along the conveyor 28, ensuring the movement of a glass container between a mould 30 and a cooling arch 32. At the entrance to the cooling arch, the temperature of the glass container is higher than 400° C., preferably higher than 500° C.

The glass container 34 moves on the conveyor parallel to a direction represented by an arrow denoted 29 in FIG. 5.

The stereovision device is placed upstream from the conveyor, preferably as close as possible to the exit of the mould 30.

The stereovision device 2 is directed so that the optical axis 16 of the sensor 4 is perpendicular or substantially perpendicular to the direction 29, so that the container 34 moves perpendicular or substantially perpendicular to the optical axis 16. The measurements made by the stereovision device 2 are then made in conditions identical or substantially identical to those made during the calibration method described hereinabove. The measurements made are thus very accurate.

The stereovision device 2 is configured to implement a control method described hereinafter, previously recorded by the storage module 24. The control method is implemented when a container 34 appears in the field of view of the sensor 4 and in the field of view 18 of the sensor 6 as illustrated in FIG. 5.

The control method comprises a first step implemented by the computation module 26, consisting in measuring simultaneously the distance E′1 between the sensor 4 and the container 34 using said sensor 4, the position P′1 of the container 34 in the field of view 18 of the sensor 6 as well as its apparent diameter D′1.

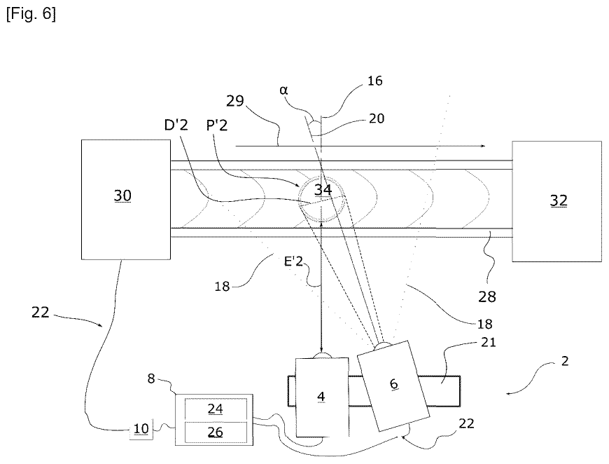

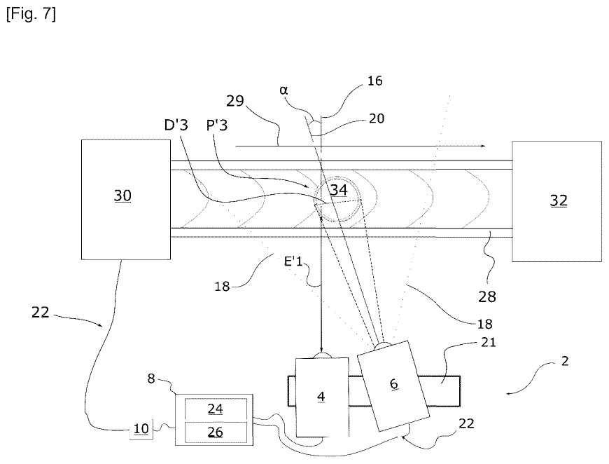

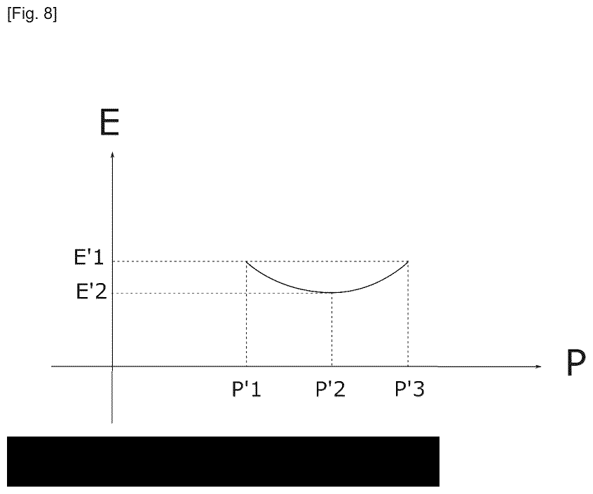

When the container 34 moves on the conveyor 28, this first step is reiterated at least three times as illustrated in FIGS. 5 to 7, in such a way as to obtain a variation of the distance value E′ between the container 34 and the sensor 4. Preferably, the first step is carried out a sufficient number of times to obtain a curve as illustrated in FIG. 8.

According to a fourth step carried out from the curve shown in FIG. 8, the computation module 26 identifies the smallest value E′ measured during the movement of the container 34. In the present case, it is the value E′2 measured when the container were at position P′2.

In a fifth step, based on the value E′2 and the positions P′1, P′2 and P′3, the computation module identifies in the database, obtained according to the calibration method described hereinabove, different real diameter values R′1, R′2, R′3 of the container.

In other words, during this fifth step, the computation module identifies, based on the value E′2, the database making it possible to identify the most accurately possible the real diameter value R of the container observed through the sensor 6, as a function of its position P in a plane perpendicular to the optical axis 16 of the sensor 4 and spaced apart by a distance E′2 from said sensor.

In a sixth step, the computation module 26 compares the real values R′1, R′2 and R′3 obtained from the selected database, to a pre-recorded reference value. In the case where the difference between a real value R′ and the reference value is greater than a predefined threshold, the computation module 26 transmits this information to the alert module 10. In the present example, the difference between the measurements has to be equal to or greater than 5%, preferably equal to or greater than 15%, for the information to be transmitted to the alert module 10.

Therefore, advantageously, the stereovision device 2 is adapted to identify a local shape imperfection of the container 34 exiting from the mould 30 and as close as possible to the latter, without having to carry out for that purpose measurements liable to deteriorate the container.

It is to be noted that the dimensions R′ of the container are obtained from the measurements made by the infrared optical sensor 6, this sensor enabling more accurate measurements of the contour of the glass container 34, with respect to the optical sensors whose sensibility is limited to the visible domain. Indeed, the sensor 6 is less sensitive to the edge effects visible on transparent or translucent containers in daylight.

In the present example, the alert module 10 is connected to the mould 30 in order to change instantaneously the operating parameters of the mould and, if necessary, to stop the operation thereof in order to limit the number of containers produced with the same manufacturing defect.

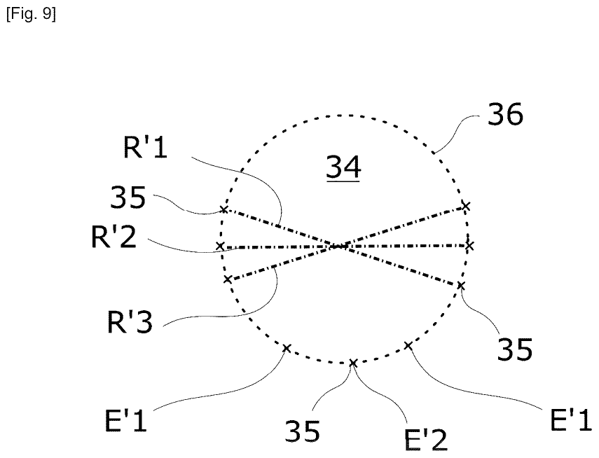

According to another advantage, the invention makes it possible to measure the real diameter R′ of a same container under different angles of view, during the movement of the container on the conveyor 28. The sensor 4 also enables to obtain several measurements E′ of a part of the container contour shape. These different measurements can be combined together in order to obtain a partial representation of the contour of the container 34, as illustrated by the crosses 35 visible in FIG. 9. Based on these measurements, a model 36 of the full contour of the container 34 can be made using known means in order to carry out a more complete control of the glass container, without it is required for that purpose to position sensors on each side of the conveyor 28. Therefore, the invention offers a control solution that is less bulky and more economical in terms of sensors.

According to an alternative embodiment not illustrated, several stereovision devices 2 as described hereinabove can be stacked onto each other so that several measurements of the container 34 can be carried out along a direction normal or substantially normal to the plane defined by the optical axes 16 and 20 of the sensors. This embodiment advantageously makes it possible to obtain a control and a three-dimensional modelling of the container. It is then possible to perform an almost complete check of conformity of the container 34, without having to remove the container from the conveyor and to stop said conveyor.

The stereovision device 2 or device for remotely controlling the shape of a hot translucent container described hereinabove thus makes it possible to control in part the shape of a glass container, as close as possible to the mould from which it exits, without having for that purpose to wait for its cooling or to carry out measurements damaging the sample. For that purpose, two optical sensors of different technologies are used, to obtain simultaneously images of the same container, in order to identify the position of the container to check that its dimensions are compliant. Advantageously, the stereovision device is relatively compact, thus easier to integrate on a production line, but also more efficient to measure the dimensions of a container whose temperature is higher than 600° C., and that way usable as close as possible to the mould from which the container exits. The stereovision device can thus be part of a control loop of the mould, which will be more reactive and thus more efficient, to limit the number of non-compliant containers manufactured.

1. A method for calibrating a stereovision device (2) comprising a chromatic distance sensor (4), an infrared optical sensor (6), the optical axes (16, 20) of the sensors intersecting each other or being secant, a control unit (8) consisted of a computation module (24) and a storage module (26), the control unit being connected to the sensors (4, 6), characterized in that the calibration method implements the following steps:
a) positioning an object (12) in the field of view of the sensors (4, 6), the object being aligned or substantially aligned with the optical axis (16) of the chromatic distance sensor (4) and at least one dimension (R) of the object is known;
b) measuring a distance (E1) between the object (12) and the chromatic distance sensor (4);
c) measuring a position (P1) of the object (12) and at least one dimension (D) of the object (12), through the infrared optical sensor (6);
d) recording into a database contained in the storage module (24) the measurements carried out at steps b) and c), in such a way that a known dimension (R) of the object (12) is correlated to the distance measurement (E1), to the measurement of at least one dimension (D1) and to the position measurement (P1) of the object (12).

2. The method for calibrating a stereovision device (2) according to claim 1, characterized in that at least one dimension (R) of the object is known in a plane defined by the optical axes (16, 20) of the sensors (4, 6).

3. The method for calibrating a stereovision device (2) according to claim 1 or 2, characterized in that, during step c), a dimension (D) of the object is measured in a plane defined by the optical axes (16, 20) of the sensors (4, 6).

4. The method for calibrating a stereovision device (2) according to any one of claims 1 to 3, characterized in that the object (12) is cylindrical in shape, the longitudinal axis thereof being perpendicular or substantially perpendicular to the plane defined by the optical axes (16, 20) of the sensors (4, 6), the outer diameter of the object being known.

5. The method for calibrating a stereovision device (2) according to any one of claims 1 to 4, consisting in reiterating steps a) to d) of the calibration method, after having moved the object (12) along the optical axis (6) of the chromatic distance sensor (4).

6. The method for calibrating a stereovision device (2) according to any one of claims 1 to 5, characterized in that the optical axes of the sensors form an acute angle (α), whose value is between 1° and 30°.

7. A device (2) for stereovision of a container comprising a chromatic distance sensor (4), an infrared optical sensor (6), the optical axes (16, 20) of the sensors being secant, a control unit (8) consisted of a computation module (24) and a storage module (26), the control unit being connected to the sensors (4, 6), characterized in that the storage module (24) comprises:
a database made based on a calibration method according to one of claims 1 to 6; and
a control method, implementing the following steps:
i. measurement, by the control unit (8), via the chromatic distance sensor (4), of a distance (E′) between the chromatic distance sensor (4) and a container (34) present in the optical fields of the sensors (4, 6);
ii. measurement, by the computation module (26), via the infrared optical sensor (6), of the position (P′) and a dimension measurement (D′) of the container (34);
iii. identification, from the database, of a value (R) correlated with the measurements (E′, P′, D′) carried out in steps i and ii;
iv. identification of a defect of the container (34), when the value (R) exceeds a predetermined tolerance range.

8. The stereovision device (2) according to claim 7, characterized in that steps i and ii are carried out simultaneously.

9. The stereovision device (2) according to claim 7 or 8, characterized in that, when a container (34) moves in the field of view of the sensors (4, 6), before step iii, steps i and ii are implemented several times.

10. The stereovision device (2) according to claim 9, characterized in that, between the last step ii and step iii, an intermediate step is implemented, consisting in identifying the shortest distance (E′) measured by the chromatic distance sensor (4), this shortest distance being taken into account during step iii to identify the value (R).

11. The stereovision device (2) according to one of claims 7 to 10, characterized in that the control unit (8) comprises an alert module (10) connected to the computation module (26), and in that the alert module (10) is activated by the computation module (26) when the computation module (26) identifies a defect of a observed container (36) during the implementation of the control method.

12. The stereovision device (2) according to claim 11, characterized in that the alert module (10) is connected to a control module of a production unit.

13. A glass container production line, comprising a mould (30) for thermoforming glass containers, a conveyor (28) adapted to move the containers exiting from the mould (30) to a cooling arch (32), characterized in that a stereovision device (2) according to one of claims 7 to 11 is present along the conveyor (28), between the mould (30) and the cooling arch (32), the optical sensors (4, 6) being directed so as to detect the passage of each container (34) moving on the conveyor (28).

14. The glass container production line according to claim 13, characterized in that the optical axis (16) of the chromatic distance sensor (4) is perpendicular or substantially perpendicular to the moving direction of the containers on the conveyor (28).

15. The production line according to claim 13 or 14, characterized in that the mould (30) is connected to the stereovision device (2) so as to stop the operation of the mould (30), when the stereovision device (2) detects a defect on a container (34) moving on the conveyor (28).
